(19) United States
(12) Patent Application Publication
(10) Pub. No.: US 2018/0066935 A1
(43) Pub. Date: Mar. 8, 2018

(54) THz Continuous Wave Thickness Profile Measurements Software Algorithms

(71) Applicant: Traycer Diagnostic Systems, Inc., Burlingame, CA (US)

(72) Inventor: Don J. Burdette, Columbus, OH (US)

(73) Assignee: Traycer Diagnostic Systems, Inc., Burlingame, CA (US)

(21) Appl. No.: 15/259,085

(22) Filed: Sep. 8, 2016

(51) Int. Cl. G01B 11/06; G01J 3/453

(52) U.S. Cl. CPC G01B 11/0633; G01J 3/453

(57) ABSTRACT

A mathematical extended bandwidth algorithm method (MEB) is used for acquiring real-time thickness profile measurements of a multi-layer sample of unknown layer thicknesses each above about 10 μm. A statistical based thickness profile algorithm method (SBTP) is used for acquiring real-time thickness profile measurements of a multi-layer sample of unknown layer thicknesses each above about 1 μm.

### CROSS-REFERENCE TO RELATED APPLICATIONS

Not applicable

### STATEMENT REGARDING FEDERALLY SPONSORED RESEARCH

Not applicable

### BACKGROUND

### Conventional THz Thickness Gauging Systems

Light at terahertz (THz) frequencies (0.1-5.0 THz) has properties that are beneficial for standoff non-destructive evaluation (NDE) of multi-layered dielectric structures. Such properties include both high transmittance through the sample and high reflectance between adjacent layer interfaces. However, there exists no non-destructive gauging method (THz based or otherwise) that can perform real-time, on-the-assembly-line measurements of multi-layer dielectric structures with layers several microns thick and index of refraction differences Δn on the order of 0.01 μm.

There are two candidate THz modalities that can be used to measure dielectric thickness stacks: time-domain (TD) and continuous wave (CW). TD methods illuminate a sample with pulses of THz radiation. These pulses are partially transmitted and reflected at each dielectric interface, resulting in a train of pulses. The thickness of each layer is extracted using the a priori knowledge of each layer's index of refraction and the timing difference between the pulses. Conversely, CW THz systems sequentially step through narrow-band THz frequencies to record a THz spectrum. The sample's thickness profile (TP) gives rise to standing wave patterns that vary the recorded signal intensity as a function of THz frequency. Typically, sample thicknesses are extracted from the data by preforming an inverse Fourier transform that recasts the data into the time-domain where the standing wave pattern manifests as a series of pulses, analogous to the TD data. Again, the a priori knowledge of the index of refraction in each region is used to extract the thickness of each layer.

The limiting factors to THz dielectric thickness-stack measurements for both TD and CW include:
1. The index of refraction difference, Δn, between adjacent layers must be large enough to reflect sufficient light to overcome the system noise; otherwise, the boundary between adjacent layers cannot be resolved. For conventional systems, index of refraction differences must be on the order of 0.05-0.1 or greater to resolve dielectric boundaries.
2. Thickness resolution. For TD systems, the thickness resolution is proportion to the width of the reflected timing pulses. State-of-the-art TD systems can resolve layer thicknesses down to 5 μm-25 μm. For CW systems, the thickness resolution is coupled to the measurement bandwidth. Finer layer structures can be resolved for systems possessing larger frequency bandwidths. The minimal thickness resolution for conventional CW gauging measurement approaches 25 μm.
3. Data collection speed. Industrial applications require measurement rates of 100-1000 Hz. TD system can achieve this rate; however, they fail to meet the specifications of the more challenging applications requiring index of refraction differences of 0.01 and minimal thickness resolution of 1.0 μm. CW systems are several orders of magnitude too slow (seconds compared to 1-10 milliseconds). Commonly owned U.S. Ser. No. 15/040,317 addresses the problem of collecting CW THz spectra at higher rates, and will not be discussed further here. For present purposes, it is assumed that the CW data is collected at the required rate.

### BRIEF SUMMARY

One aspect of this disclosure is a mathematical extended bandwidth algorithm method (MEB) for acquiring real-time thickness profile measurements of a multi-layer sample of unknown layer thicknesses each above about 10 μm. The MEB method starts by collecting continuous wave (CW) spectrum data of the sample. A gain-correction to the CW spectrum data is applied to normalize the standing-wave pattern. The gain-corrected spectrum data is fitted to an a priori mathematical model using best-fit parameters as an initial guess. A Fourier transform (FT) is performed on the resulting extended bandwidth spectrum to a time domain to yield a pulse train. Finally, the timing differences of the resultant pulse train are analyzed to extract a thickness profile of the sample.

Another aspect of the disclosure is a statistical based thickness profile algorithm method (SBTP) for acquiring real-time thickness profile measurements of a multi-layer sample of unknown layer thicknesses each above about 1 μm. This method commences by compiling a library of noiseless terahertz (THz) spectra for various known thickness profiles (TP). For each simulated TP THz spectrum, a noise model is applied to the data and an estimation maximization (EM) algorithm is applied to determine which noise TP most closely matches a noiseless TP. The EM algorithm must be applied at least 100 times on up to 1,000 times or more. A histogram of the TPs returned from the EM algorithm is created. This process is repeated for each simulated TP, resulting in a library of histograms that will be used to tag the thickness profile of an unknown sample. The method is repeated for a sample of unknown thickness. The results from the known histograms are compared to the results of the unknown histograms to determine the closest match and, hence, the thickness of the unknown sample.

### BRIEF DESCRIPTION OF THE DRAWINGS

For a fuller understanding of the nature and advantages of the present method and process, reference should be had to the following detailed description taken in connection with the accompanying drawings, in which:

FIG. 1A is an example gain-corrected data for a two layer structure for a typical THz spectrometer of bandwidth (0.1-1.2 THz). The a priori model and initial fit parameters are used to fit to the unknown layer structure and new fit parameters are extracted. In FIG. 1B, the fit parameters extracted from the data in FIG. 1A are used by the mathematical model of the sample to artificially extend the bandwidth. This data is then Fourier transformed to the time-domain to extract the layer thicknesses.

FIG. 2 graphically displays an example gain-corrected data for a two-layer structure for a typical THz spectrometer of bandwidth (0.1-1.2 THz) on the left. The a priori model and initial fit parameters are used to fit to the unknown layer structure and new fit parameters are extracted and the fit parameters extracted from the data on the left are used by the mathematical model of the sample to mathematically extend the bandwidth on the right. This data is then Fourier transformed to the time-domain to extract the layer thicknesses.

FIG. 3 graphically displays data from FIG. 2 that is Fourier transformed to the time-domain with (Sim 1, Sim 9) and without (Sim 1) the extended bandwidth correction. In the case of the bandwidth correction the two layers are clearly resolved.

FIG. 4 graphically displays the gain-corrected spectra for various target thicknesses.

FIG. 5 graphically displays a two-dimensional histogram of the results of this study: failure.

FIG. 6 graphically displays the projections of the data in FIG. 5 as 2-D histograms.

FIGS. 7A, 7B, and 7C graphically displays the stability of histograms for N=1000 measurements. High stability was observed; thus, a statistical method of the errors of a maximization algorithm can be used to tag thickness profiles even in extreme amounts of noise.

FIG. 8 is a graphical map of statistical fingerprint to thickness profile for the example two-layer system.

The drawings will be used in the following description of the disclosure.

### DETAILED DESCRIPTION

Software algorithms can be used to overcome thickness resolution limitations that arise due to the limited THz bandwidth of CW THz spectrometers. The selection of an appropriate data analysis method is sample dependent. Specifically, the choice of algorithm depends on the thickness of each layer and the index of refraction difference (Δn) between adjacent layers. For dielectric stacks with layer thicknesses on the order of 10 μm and Δn≧0.1, a Mathematical Extended Bandwidth (MEB) algorithm can be used. For thickness down to 1.0 μm and Δn≧0.01 a Statistical Based Thickness Profile (SBTP) technique is required. Both algorithms rely on a priori knowledge of: 1) the index of refraction of each layer as a function of THz frequency, 2), the thickness profile structure, 3) a reasonable starting guess of the thickness of each layer, and 4) that the thickness of each layer does not vary radically from the target thickness (on the order of 100% deviation from the desired thickness).

### Algorithm 1: Mathematical Extended Bandwidth (MEB) Algorithm

The MEB algorithm is based on the assumption that standing wave structures observed in the THz spectrum are periodic, and that their structure can be modeled mathematically. Under this assumption, the CW THz spectrum of the target thickness profile is collected. Either simulated data or real-data collected from a set of test samples can be used. A mathematical model is found that best fits the acquired spectrum. The best-fit parameters are used as initial guesses in subsequent data analysis. The fitting algorithm that is used to extract the ‘best-fit’ parameters will be sample dependent.

The following steps outline the MEB algorithm for acquiring real-time thickness profile measurements.
1. Collect the CW THz spectrum of the sample.
2. Apply a gain-correction to the data to normalize the standing-wave pattern.
3. Fit the gain-corrected spectrum to the a priori mathematical model using the ‘best-fit’ parameters as an initial guess.
4. Use the new fit parameters to mathematically extend the CW THz spectrum (for example, 0.1 THz-1.2 THz to 0.1 THz-5.0 THz)
5. Fourier transform the extended bandwidth spectrum to the time-domain.
6. Analyze the timing differences of the resultant pulse-train to extract the thickness profile.
7. Repeat the process using the fit-parameters from the current measurement as the initial guess for the subsequent measurement.

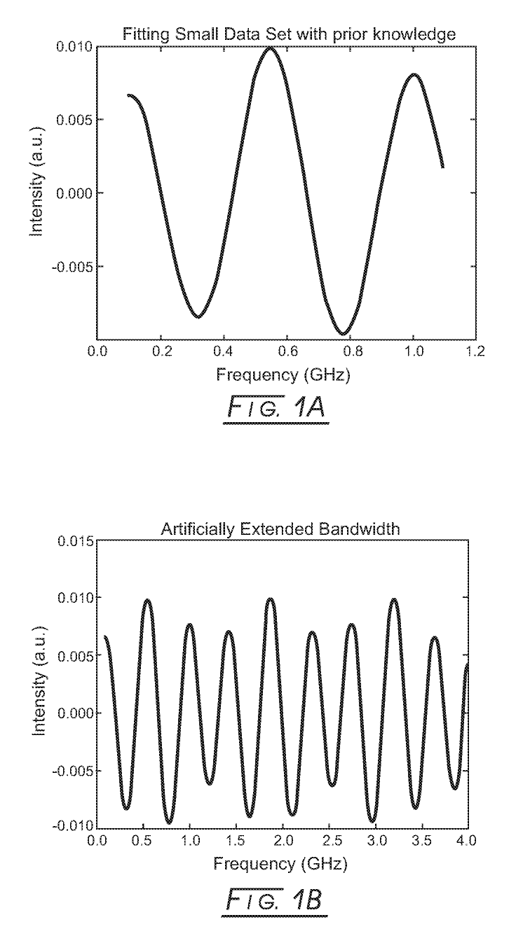

To illustrate this technique, consider the following example. The sample is a two-layer dielectric structure with an ideal thickness profile of 200 μm and 100 μm and refractive indices of 1.5 and 1.6, respectively. A sum of sines mathematical model was used to extract the initial ‘best-fit’ parameters. FIGS. 1A and 1B show simulated gain-corrected THz spectral data for an attainable THz bandwidth of 0.1-1.2 THz. The best-fit parameters are used to fit this data. The new, updated fit parameters are extracted from the best-fit and used to mathematically extended the bandwidth to 4.0 THz.

The final step is to Fourier transform the mathematically extended bandwidth to the time-domain and measure the timing differences between the pulses. The larger bandwidth translates to finer timing-pulse widths, allowing the measurement to resolve finer thickness than could be achieved using the raw data alone. FIG. 2 shows the post-Fourier transformed data with and without the MEB algorithm.

This MEB algorithm fails as the layer thicknesses decrease below 10 μm because the standing wave period becomes much longer than the sampling bandwidth. The thickness profile for such samples can still be extracted from the data; however, a statistical sampling based approach is required.

### Technique 2: Statistical Based Thickness Profile (SBTP) Algorithm

The SBTP algorithm relies on a priori knowledge of a discrete sampling of possible layer thicknesses. The step size for each thickness in the stack will be application dependent. The THz spectrum for each thickness profile (TP) is stored to a file for comparison to real-data that is collected from a sample with identical layer structure but unknown layer thicknesses. The repository data can either be generated using a simulation or a set of test samples with known TPs.

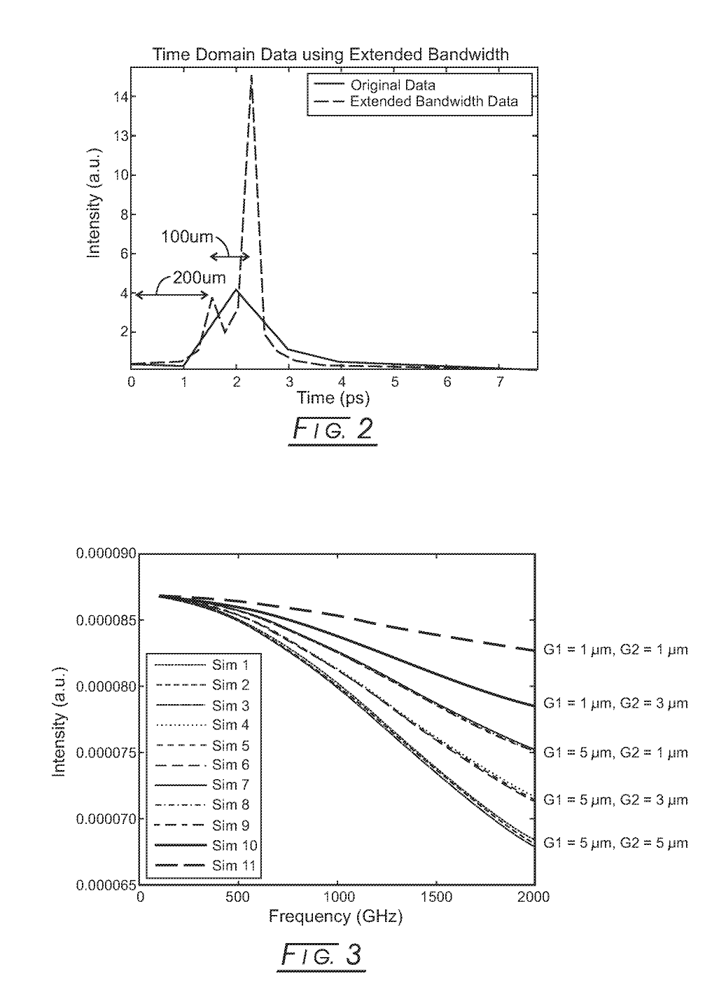

The following example illustrates the motivation of the SBTP algorithm. FIG. 3 shows noiseless, gain-corrected THz spectra collected from 0.1-2.0 THz using the COMSOL simulation package (Comsol, Inc., version 5.1.0.145) for a two layer sample with layer thicknesses ranging from 1.0 μm to 5.0 μm in 1.0 μm steps. The refractive index of the samples are 1.50 and 1.51 (Δn=0.01).

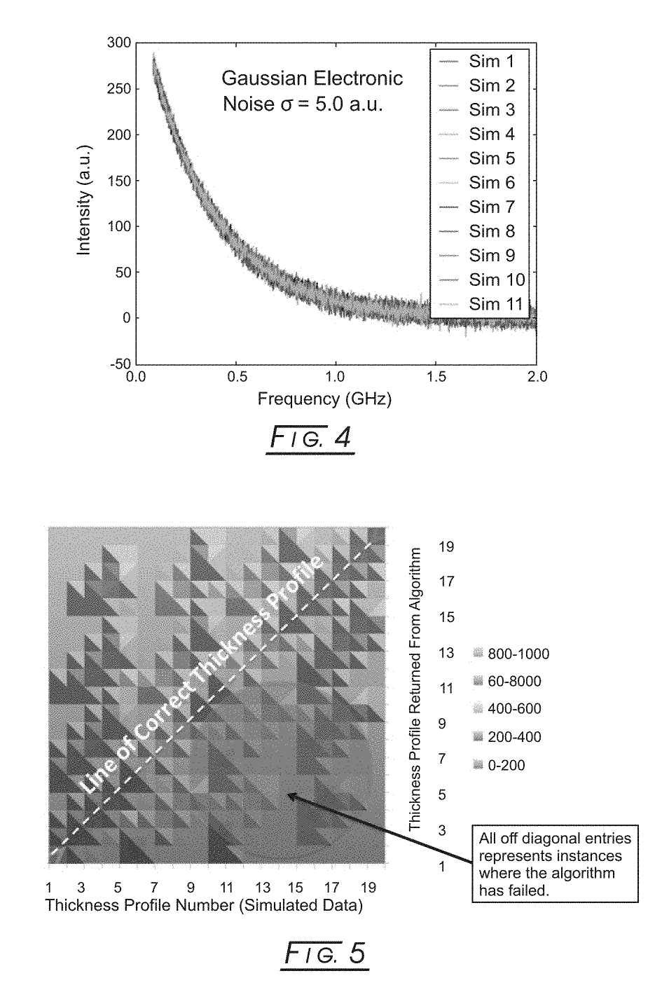

Initially, software algorithms were investigated that used maximization likelihood estimation techniques to determine the thickness profile that most likely produced the observed data. This technique failed when realistic noise sources and detector/emitter dynamic range were included in the simulation (FIG. 4). FIG. 5 shows a two-dimensional histogram of the results of this study. The y-axis is the Thickness Profile Number of the simulated layer structure and the x-axis is the TP that was returned by the algorithm. One thousand trials were preformed for each TP. Had our maximum likelihood estimation based technique worked, histogram elements would only appear on the diagonal.

However, further analysis of the data has revealed an underlying structure to the data that can be used to tag the correct TP with high accuracy. The trade-off is that instead of one THz spectral measurement equating to one TP measurement, that many THz spectra (100-1000) are needed to reach the desired measurement metrics (1.0 μm thickness changes, Δn=0.01).

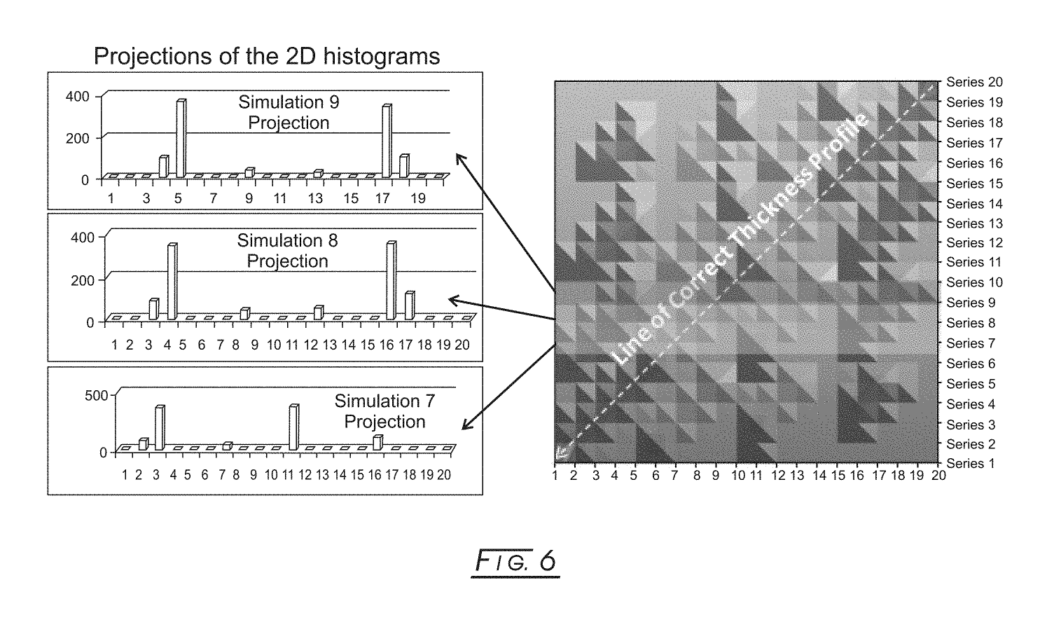

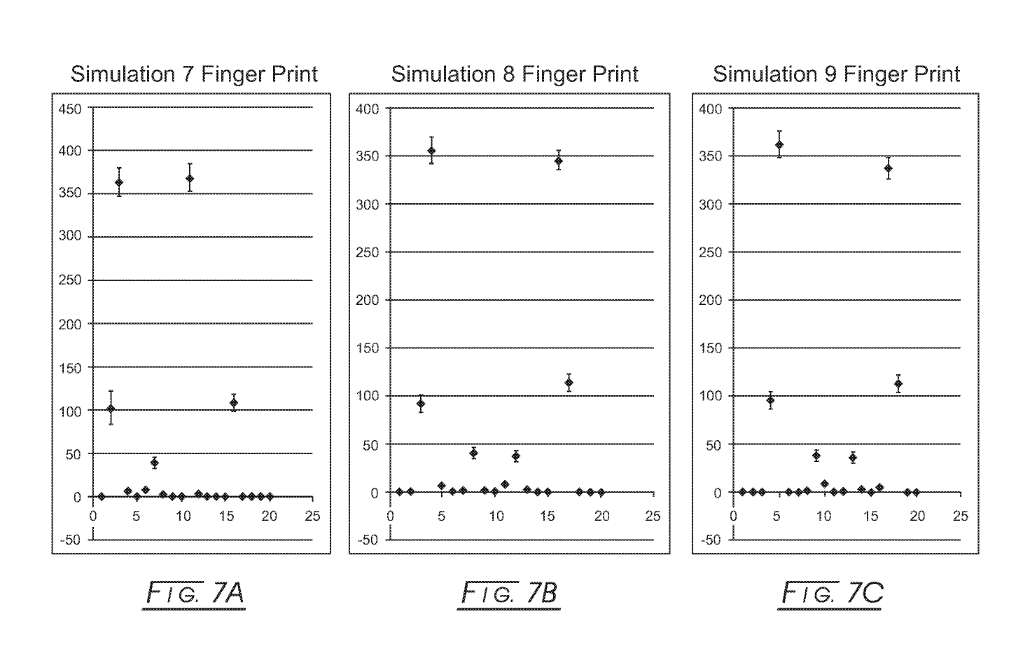

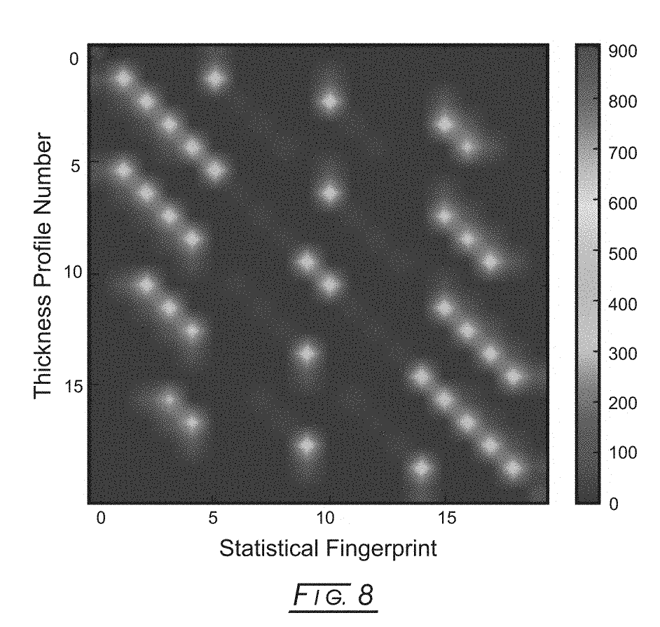

To illustrate, consider a slice of the 2D histogram along the y-axis (FIG. 6). For a single 1000 event sample, this information is not useful in and of itself. However, if we performed the same experiment 1000 times, each with 1000 events, a measurement of the repeatability of these histogram patterns emerges. FIGS. 7A, 7B, and 7C show the result of such an experiment. The error bars on the plots show the standard deviation for the 1000 trial study. It has been discovered that the error patterns are highly repeatable and unique enough for each TP to allow each layer thickness to be correctly identified.

Recasting the algorithm results with this new mindset, the histogram shown in FIG. 5 is more than just a distribution of errors; instead, it is a statistical fingerprint that enable thickness profiles to be differentiated.

FIG. 8 shows the statistical fingerprint for each thickness profile of our two-layer system. This plot shows that the distributions are unique and can be used with high confidence to tag the thickness profile of samples.

In summary, there are two stages to the SBTP algorithm consisting of the following steps.

### Stage One: Build an a Priori Statistical Fingerprint Map

Step 1. Compile a library of noiseless THz spectra for various thickness profiles (TP) using a simulation model. Only the thickness of the layers (not the material of the layers themselves) is altered.
Step 2. Generate statistical fingerprint for each TP
   Step 2.1 Add the expected system noise to the spectra.
   Step 2.2 Use a estimation maximization technique (algorithm) to determine which TP (from the library generated in Step 1) most closely matches the noisy data. For high noise systems (like the system described here) the result of this operation will not consistently yield the correct result. This is expected.
   Step 2.3 Repeat Step 2.2 N times. In the example above N=1000.
   Step 2.4 Histogram the TPs returned by the algorithm. This is the statistical fingerprint for the TP.
Step 3. Repeat step 2 for every TP spectra in the library. This will create a statistical fingerprint for each TP and will serve as a map that will be used to identify the most likely TP of the actual measurement.

### Stage Two: TP Measurement

Step 4. Collect N (the same N as Step 2.3) real THz spectra of a sample with an unknown TP. Since the data is collected from a real system, it will have the same noise profile as was added to the simulated spectra.
Step 5. Use the same estimation maximization technique from Step 2.2 for each of the N THz spectral measurement and histogram the estimated TPs returned by the algorithm. This is the statistical fingerprint of the sample that will be used to tag the TP.
Step 6. Compare the statistical fingerprint measured in Step 5 to the statistical finger print map generated in Step 3 to extract the TP of the unknown sample.

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application all citations set forth herein are expressly incorporated herein by reference.

I claim:

1. A mathematical extended bandwidth algorithm method (MEB) for acquiring real-time thickness profile measurements of a multi-layer sample of unknown layer thicknesses each above about 10 μm, comprising the steps of:
(a) collecting continuous wave (CW) spectral data of the sample;
(b) applying a gain-correction to the CW spectral data to normalize the standing-wave pattern;
(c) fitting the gain-corrected spectral data to an a priori mathematical model using best-fit parameters as an initial guess;
(d) performing a Fourier transform (FT) the resulting extended bandwidth spectrum from step (c) to a time domain to yield a pulse train; and
(e) analyzing the timing differences of the resultant pulse train in step (d) to extract a thickness profile of the sample.

2. The MEB method of claim 1, additionally comprising the step of:
(f) repeat steps (c) through (e) using the measurements in step (e) for step (b).

3. A statistical based thickness profile algorithm method (SBTP) for acquiring real-time thickness profile measurements of a multi-layer sample of unknown layer thicknesses each above about 1 μm, comprising the steps of:
(a) compiling a library of noiseless terahertz (THz) spectra for various known thickness profiles (TP);
(b) add simulated system noise to a TP spectrum and apply an estimation maximization algorithm to determine which noiseless TP the noisy TP most closely matches;
(c) repeat step (b) at least 100 times and create a histogram of the TPs returned by the estimation maximization algorithm. This histogram is the statistical fingerprint for the current TP;
(d) Repeat steps (b) through (c) for each simulated TP to create a statistical fingerprint map
(e) collect at least 100 THz spectra from a real, noisy system
(f) use the estimation maximization algorithm to generate a histogram of TPs returned by the algorithm. This histogram is the statistical fingerprint of the real sample with unknown TP.
(g) compare the statistical fingerprint in step (f) to determine the statistical fingerprint map from step (d) to extract the TP of the sample.
